(19) United States
(12) Patent Application Publication
(10) Pub. No.: US 2025/0044868 A1
(43) Pub. Date: Feb. 6, 2025

(54) COLLABORATION MODE TRANSITION BASED ON COGNITIVE OVERLOAD

(71) Applicant: International Business Machines Corporation, Armonk, NY (US)

(72) Inventors: Carolina Garcia Delgado, Zapopan (MX); Sarbajit K. Rakshit, Kolkata (IN); Jill S. Dhillon, Jupiter, FL (US); Fang Lu, Billerica, MA (US)

(73) Assignee: International Business Machines Corporation, Armonk, NY (US)

(21) Appl. No.: 18/228,215

(22) Filed: Jul. 31, 2023

(51) Int. Cl. G06F 3/01

(52) U.S. Cl. CPC G06F 3/015; G06F 3/012

(57) ABSTRACT

An embodiment determines, by a collaboration mode transition engine, based on biometrics data and behavioral data, a cognitive level of a user associated with a first collaboration mode in a plurality of collaboration modes. The embodiment determines, by the collaboration mode transition engine, based on collaboration mode usage data associated with the first collaboration mode, a cognitive level threshold of the user for the first collaboration mode. The embodiment selects, by the collaboration mode transition engine, responsive to a determination that the cognitive level exceeds the cognitive level threshold, a second collaboration mode in the plurality of collaboration modes. The embodiment transitions, by the collaboration mode transition engine, to the second collaboration mode.

### BACKGROUND

The present invention relates generally to virtual collaboration. More particularly, the present invention relates to a method, system, and computer program for collaboration mode transition based on cognitive overload.

The evolution of digital technology has introduced various mediums and platforms for communication, each with unique interface settings and presentation styles. Text-based application, for instance, are designed to allow users to send and receive messages instantly, share documents, and even have voice and video calls. These platforms have become integral to contemporary workspaces, educational institutions, and personal communications. The screen display, including factors like font style and size, color scheme, and layout, play a crucial role in the user experience. These applications usually offer personalization options to suit individual user preferences and comfort.

Virtual reality (VR) is an immersive technology that simulates a user's physical presence in a digital environment, and its use has escalated in areas like gaming, education, and virtual meetings. In contrast to text-based platforms, virtual reality interfaces often use graphical and visual representations to convey information and support interaction. The primary mode of interaction in virtual reality is often through movements, gestures, and spoken commands, rather than typing.

### SUMMARY

The illustrative embodiments provide for collaboration mode transition based on cognitive overload. An embodiment includes determining, by a collaboration mode transition engine, based on biometrics data and behavioral data, a cognitive level of a user associated with a first collaboration mode in a plurality of collaboration modes. The embodiment also includes determining, by the collaboration mode transition engine, based on collaboration mode usage data associated with the first collaboration mode, a cognitive level threshold of the user for the first collaboration mode. The embodiment also includes selecting, by the collaboration mode transition engine, responsive to a determination that the cognitive level exceeds the cognitive level threshold, a second collaboration mode in the plurality of collaboration modes. The embodiment also includes transitioning, by the collaboration mode transition engine, to the second collaboration mode. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment.

FIG. 2 depicts a block diagram of an example software integration process in accordance with an illustrative embodiment.

FIG. 3 depicts a graphical representation of an example collaborative environment in accordance with an illustrative embodiment.

FIG. 4 depicts a block diagram of an example process for collaboration mode transition in accordance with an illustrative embodiment.

FIG. 5 depicts a block diagram of an example process for collaboration mode transition based on cognitive overload in accordance with an illustrative embodiment.

FIG. 6 depicts a block diagram of an example process for transitioning to a virtual reality collaboration mode in accordance with an illustrative embodiment.

FIG. 7 depicts a block diagram of an example process for collaboration mode transition based on cognitive overload in accordance with an illustrative embodiment.

### DETAILED DESCRIPTION

The evolution of digital technology has seen the introduction of various mediums and platforms for communication, each with its own unique set of interface settings and presentation styles. Text-based applications, for instance, enable users to send and receive messages instantaneously, share documents, and even conduct voice and video calls. They have become an integral part of contemporary workspaces, educational institutions, and personal communications.

The screen display of these applications often plays a significant role in the user experience. Factors such as font style and size, color scheme, and layout all contribute to how users interact with and perceive these platforms. These applications usually offer personalization options to accommodate individual user preferences and comfort. Yet, the variations in these settings across different devices and platforms can lead to fatigue or strain as users switch from one to another.

On the other hand, virtual reality is an immersive technology that simulates a user's physical presence in a digital environment. Its use has escalated in areas like gaming, education, and virtual meetings. Unlike text-based platforms, virtual reality interfaces use graphical and visual representations to convey information and support interaction. The primary mode of interaction in virtual reality is often through movements, gestures, and spoken commands, rather than typing.

With virtual reality, user endurance may be challenged differently compared to traditional communication platforms. Extended usage might lead to phenomena such as motion sickness, eye strain, or discomfort due to the physical aspect of wearing virtual reality headsets. Adjusting to and transitioning between these diverse communication environments can indeed be challenging for users, as they may demand varying levels of cognitive and physical effort. Moreover, these transitions may also require users to adapt to the specific visual presentation and interaction styles of each platform.

The present disclosure addresses the deficiencies described above by providing a process (as well as a system, method, machine-readable medium, etc.) that, based on historical biometric data and behavior patterns, may identify a user's endurance score for different modes of collaboration. This system may use this information to determine when a user should switch from one mode of collaboration to another to maximize the overall effectiveness of the interaction. While a user is engaged in any form of collaboration (e.g., textual or VR), the system may continuously analyze cognitive overload by examining biometric and behavioral parameters. It may then identify an appropriate mode of collaboration to mitigate current fatigue levels, and seamlessly transition the user to this secondary mode of collaboration.

Illustrative embodiments provide for collaboration mode transition based on cognitive overload. A “collaboration mode,” as used herein, may refer to the method or platform used for interaction and communication between individuals or teams. For example, a collaboration mode could be a text-based communication platform, an audio-based communication platform, or an immersive environment provided by virtual reality technologies. “Collaboration mode transition,” as used herein, may refer to the process of switching from one mode of collaboration to another. For example, a user might transition from a textual conversation on a text-based application to an immersive discussion in a virtual reality environment, as dictated by their comfort, convenience, or the specific needs of their interaction. “Cognitive overload,” as used herein, may refer to the state where an individual experiences cognitive fatigue, causing their cognitive processing capacity to be exceeded. For example, extended periods of interacting with a text-based application, engaging with visually intense or fast-paced environments like virtual reality, of multi-tasking on multiple collaboration applications may induce cognitive overload, leading to fatigue, errors, or reduced efficiency.

Illustrative embodiments provide for determining a cognitive level of a user. A “cognitive level,” as used herein, may refer to the measure of an individual's mental capacity to process information and perform tasks. This measure may encapsulate various dimensions such as attention span, memory capability, problem-solving ability, decision-making speed, and mental endurance. The cognitive level could be represented as a score, which may be computed based on a variety of factors, including but not limited to biometrics data, behavioral data, the user's or other users' prior interactions in the particular mode of collaboration or similar modes, among others.

For example, in some embodiments, a cognitive level may be determined based on biometrics data and/or behavioral data. “Biometric data,” as used herein, may refer to biological and physical characteristics that are unique to an individual and can be digitally analyzed. This data can include information such as heart rate data collected via wearable sensors, breathing rate data collected via acoustic sensors or smart clothing, facial expressions detected through artificial intelligence facial recognition systems (e.g., eye shape or movement captured through eye-tracking technologies), or any other suitable information. These data points may serve as physiological markers of a user's cognitive load during a mode of collaboration, thereby informing the cognitive level calculation.

“Behavioral data,” as used herein, may refer to digital records of user actions and decisions within a system or platform. This data, which may be machine-learned from vast datasets, may offer insights into a user's typical engagement duration in a particular collaboration mode, the tasks they excel at, the points at which they start losing focus or showing signs of fatigue, changes in their cognitive state, among other information. For example, behavioral data may include response time data captured through keylogging software, response accuracy data captured through task performance analysis tools, and distraction data captured through eye-tracking technologies or image processing software.

In some embodiments, the system may apply a machine learning model to determine a cognitive level. For example, the system may apply a deep learning model, such as a convolutional neural network, to determine a user's cognitive level. A convolutional neural network is a type of model that may effectively process grid-like data (including images and time-series data), which could be beneficial for processing high-dimensional biometric and behavioral data. However, any other machine learning architecture may be used, as would be appreciated by those having ordinary skill in the art upon reviewing the present disclosure.

This deep learning model could be trained to determine the cognitive level based on a plurality of cognitive levels from a multitude of users. Training the model may involve the utilization of training data, which may include users' historical cognitive levels, associated tasks and activities, performance metrics, and individual biometric and behavioral data. The model may be trained using a suitable learning algorithm, such as stochastic gradient descent, which adjusts the network's weights iteratively. This adjustment may occur based on the difference between the predicted cognitive level (the model's output) and the actual cognitive level from the training data. The training process may continue until the model's predictions align closely with the actual levels. During the training process, measures may be taken to prevent overfitting, such as validating the model on a separate dataset. Moreover, techniques like dropout or early stopping could be deployed to help prevent overfitting. The model may be fine-tuned or retrained as additional user data becomes available, enabling the system to adapt and evolve with changing user behavior and needs. To determine a specific user's cognitive level, the system may input the user's individual data (e.g., biometric and/or behavioral data) into the trained model. The deep learning model would then process this data, identifying patterns and associations related to cognitive levels. The output may be a predicted cognitive level, providing a quantifiable metric for a user's current cognitive state during a particular task or collaboration mode.

For example, the system could use a specialized convolutional neural network designed for image processing to incorporate facial recognition data in the determination of cognitive level. The model may be able to extract relevant features from facial images, like eye squinting or yawning, that could signify cognitive load or fatigue. During training, the model may learn from a vast dataset of facial images associated with various cognitive levels. These images could be labeled with information such as whether the user was experiencing cognitive overload or was at an optimal cognitive state when the image was captured. The model may learn to associate different facial features or combinations of features with different cognitive levels. In real-time operation, the system may capture a user's facial image through a webcam or other similar device. This image would then be input into the model, which may then process the image and identify relevant features. The model could then output a cognitive level prediction based on these identified features. This cognitive level prediction, in conjunction with other data, could be used to determine the user's overall cognitive level.

Illustrative embodiments provide for determining a cognitive level threshold of a user. A “cognitive level threshold,” as used herein, may refer to a maximum or near-maximum cognitive load that an individual can handle without suffering a decline in performance or experience. Determining this cognitive level threshold can involve a series of computational operations, which may be powered by machine learning techniques, to analyze the user's collaboration mode usage data for a particular collaboration mode. This data could include the duration of the session, the frequency and types of tasks completed, the tools or applications used, interaction patterns with other collaborators, response times, error rates, break intervals, and user feedback, among others. The system might analyze collaboration mode usage data from the user over multiple collaboration sessions of the same collaboration mode. Over time, the system could recognize patterns and correlations between these data and moments where the user shows signs of cognitive overload.

In some embodiments, the system may apply a machine learning model, such as a deep learning neural network, to determine a cognitive level threshold. A deep learning model, such as a multi-layer perceptron, could be employed to analyze this vast and varied collaboration mode usage data. The model may be trained on a significant volume of collaboration mode usage data from a diverse user base. Each data point in the training dataset may include a detailed profile of the user's collaboration session activities, alongside an associated cognitive level threshold, providing a basis for the model to learn the relationship between the input (collaboration mode usage data) and output (cognitive level threshold). The training process could utilize backpropagation and an appropriate optimization algorithm, such as stochastic gradient descent, to reduce the discrepancy between the predicted and actual cognitive level thresholds in the training dataset. Techniques like regularization, dropout, and early stopping could be employed to prevent overfitting and enhance the model's ability to generalize. Once trained, the model may be capable of processing new collaboration mode usage data from an individual user and outputting a predicted cognitive level threshold for that user. For instance, it might identify a user who usually starts making more mistakes and takes longer breaks after one hour of continuous collaboration in a virtual reality collaboration mode, determining that this user's cognitive level threshold is approximately one hour for such tasks.

Illustrative embodiments provide for selecting, responsive to a determination that the cognitive level exceeds the cognitive level threshold, another collaboration mode. Selecting another collaboration mode may involve analyzing the user's prior performance and comfort level in different modes, calculating the projected cognitive load in these alternative modes, and selecting the one that would optimally reduce the user's cognitive overload. For instance, a user who shows cognitive overload during a video conference might be shifted to an asynchronous collaboration mode like email or project management platforms where they can engage at their own pace. The system may employ a machine learning model trained to select the most appropriate collaboration mode for a user, which may be trained in the same or similar manner as explained above based on information from multiple users and multiple collaboration modes.

For instance, if a user's cognitive level falls below the user's cognitive level threshold, the system may identify an optimal collaboration mode to alleviate the user's current cognitive overload using a machine learning model. The system may then initiate a seamless transition to this second mode, ensuring uninterrupted collaboration. For example, a user that exceeds their cognitive level threshold for virtual reality mode might be transitioned to a less demanding textual mode until their cognitive state recovers.

Illustrative embodiments provide for transitioning to the selected collaboration mode. Transitioning to the selected collaboration mode may include using application programming interfaces (APIs) or other interfaces to integrate the current collaboration platform with the selected one, automatically transferring session details, and notifying the user about the shift. For instance, in a transition from a video conference to a project management platform, the system might automatically create a new task in the platform based on the conference agenda, inviting all participants and sending them a notification about the change.

For example, the system may determine to transition to a virtual reality collaboration mode. This process may involve creating a virtual reality collaboration environment, which could include rendering a 3D virtual space, initializing virtual avatars for each participant, and setting interaction rules based on the collaboration context. It may also involve initiating a virtual reality collaboration in the virtual reality collaboration environment, which could include transferring the user's virtual reality headset and controller settings, synchronizing the audio and video feeds, and providing a brief onboarding session if needed.

Illustrative embodiments provide for translating a collaborative interaction. Translating a collaborative interaction may include converting the content or context of an interaction from one mode to another, ensuring a coherent and consistent collaboration experience across different modes. For example, in some embodiments, the system may accommodate varying participation modes during a collaboration (e.g., some users in textual mode, others in virtual reality mode), and the synchronization of these disparate modes, such as adapting the delay in typing text to coincide with a virtual reality avatar speaking the content. Additional, the system may accommodate varying participation modes during a collaboration (e.g., some users in textual mode, others in virtual reality mode) and synchronize these disparate modes. For instance, it could adapt the delay in typing text to coincide with a virtual reality avatar speaking the content, maintaining a natural rhythm in the conversation across different modes. This process may allow for a more inclusive and coherent collaboration experience, irrespective of the chosen modes of participation. Further, in some embodiments, the system might facilitate a seamless transition from virtual reality to textual collaboration by automatically generating a textual summary of the virtual reality interactions. It may identify the most effective method of translating the collaborative interaction, ensuring that the essence of the virtual reality experience is captured in the textual format.

For instance, following the example above, if the system determines to transition to a virtual reality collaboration mode, it may generate a virtual reality avatar associated with another user interacting with another collaboration mode (e.g., textual-based or audio-based collaboration modes). This process may involve using 3D modeling tools and avatar customization settings based on the user's profile. The system may then translate a user interaction of the other user to the virtual reality collaboration environment. This process may involve mapping the user's textual or auditory inputs to their avatar's speech or gestures using natural language processing and motion capture technologies. The system may then update the virtual reality avatar of the other user, which could involve real-time rendering of the avatar's actions and expressions based on the translated interactions.

Illustrative embodiments provide for predicting a recovery time. A “recovery time,” as used herein, may refer to the time needed for an individual to restore their cognitive capabilities after reaching or nearing their cognitive level threshold. Determining a recovery time may involve analyzing historical data on the user's cognitive recovery patterns, their current cognitive level, and the nature of the cognitive overload. For example, if the user typically requires a 30-minute break after a 2-hour intensive brainstorming session, the system might set this duration as the recovery time. Subsequently, the system may remain in the new collaboration mode for at least the recovery time. This process may involve monitoring the user's cognitive level during the recovery time and only suggesting a return to the previous mode (or another collaboration mode) when the cognitive level falls below the threshold.

Illustrative embodiments include identifying a plurality of devices associated with the user. A device may be any electronic tool or system that can facilitate collaboration, such as a computer, smartphone, tablet, virtual reality headset, or smart speaker. Identifying a plurality of devices may involve querying the user's account settings, examining device connectivity data, using geolocation data, or using device detection software. For example, the system might identify that the user regularly uses a laptop for email collaborations, a smartphone for instant messaging, and a virtual reality headset for virtual meetings. The system may then identify a plurality of collaboration applications from the plurality of devices, which could involve analyzing the device's installed app list, the user's usage statistics, or using app recognition algorithms. The system may then identify the plurality of collaboration modes from the plurality of collaboration applications, which could involve extracting the collaboration features of each application and categorizing them into different modes. For example, one application could provide textual, auditory, and visual collaboration modes, another application might offer textual and auditory modes, and yet another application may represent a fully immersive virtual reality mode.

Illustrative embodiments provide for determining a collaboration mode transition based on collaboration effectiveness. “Collaboration effectiveness,” as used herein, may refer to a metric assessing the quality, productivity, and/or impact of a user's contributions during a collaborative session. It may dynamically evolve with a user's cognitive state and the overall context of collaboration. For instance, if a user's responses during a textual collaboration start becoming sparse or off-topic, it could indicate reduced collaboration effectiveness, necessitating a collaboration mode transition.

In some embodiments, for example, the system may monitor the user's effectiveness and interaction behavior during a specific mode of collaboration, and determining when a transition to a second mode would enhance the overall collaboration effectiveness. For example, the system may monitor the user's effectiveness and interaction by analyzing the user's input frequency, response quality, proactive initiations in the collaboration, among other factors. The system may then determine when a transition to a second mode would likely enhance the overall collaboration effectiveness, such as through the use of machine learning algorithms.

Illustrative embodiments provide for determining a collaboration mode transition based on a collaboration topic. A “collaboration topic,” as used herein, may refer to the subject matter of the collaboration session. The system may, for instance, determine that different topics might be better suited to different modes of collaboration. For instance, a brainstorming session might be best handled in a virtual reality collaboration mode where ideas can be represented visually, while a policy discussion might work well in a textual mode.

In some embodiments, the system may consider a topic of any ongoing collaboration to select an appropriate collaboration mode. The topic may be inferred from the textual content or predefined by the users, to select an appropriate collaboration mode. For example, if the topic is “3D Design Review,” the system might propose a virtual reality mode for a more interactive and immersive experience.

Additionally or alternatively, in some embodiments, the system may consider a collaboration agenda to determine which topics are most suitable for specific collaboration modes. Here, the system may determine which topics are best suited for specific collaboration modes, potentially transitioning between modes as the discussion progresses from one topic to the next. This process may personalize the collaboration experience, making it more efficient and engaging.

Illustrative embodiments provide for determining a collaboration mode transition based on a predetermined duration. The duration, which may be set by the user or the system, may serve as a benchmark for when to initiate a shift from one mode of collaboration to another. The predetermined duration may be determined based on several factors. For example, the duration may be informed by historical collaboration data. The system may use machine learning algorithms to analyze the user's historical collaboration data, observing how long the user typically stays productive and engaged in a certain collaboration mode. For instance, if a user's performance in virtual reality collaborations typically declines after 60 minutes, the system may set this as the predetermined duration for transitions. Additionally or alternatively, the user themselves may set their preferred duration for each mode of collaboration, which could vary based on their personal comfort and cognitive capacity.

As another example, real-time biometric data like heart rate or eye movement may be used to gauge how well the user is handling the current mode of collaboration, potentially extending or reducing the duration. Moreover, actively soliciting feedback from the user may allow the system to adapt the duration to their current needs and capabilities. Furthermore, the type of collaborative environment or hardware may impact the duration. For instance, intense brainstorming sessions in a virtual reality environment may require shorter durations to prevent cognitive overload, while less intensive environments like audio or text-based collaborations could sustain longer durations. By considering these factors, the system may optimally manage transitions between different modes of collaboration, enhancing the user experience and overall effectiveness of the collaboration.

Illustrative embodiments provide for determining a collaboration mode transition based on a user engagement. A “user engagement,” as used herein, may refer to the degree of a user's active involvement and participation in a collaboration session. This might be measured by tracking the user's activities (e.g., interactions with the system or other users, frequency of inputs) and their responsiveness to various collaboration events.

For example, in some embodiments, the system might determine a user's engagement in virtual reality collaboration by analyzing how they interact with the virtual environment and other participants, represented as avatars. It could evaluate the appropriateness of the user's body language and gestures, ensuring they align with the sentiment and context of the conversation. If the user's engagement level falls below a certain threshold, the system might initiate a transition to a more suitable collaboration mode.

Illustrative embodiments include presenting an opt-in option to the user for sharing of data. This option may be presented as a user interface element during the initial setup of the system or at pertinent junctures where data sharing becomes necessary. Upon encountering the opt-in prompt, users can consciously decide whether or not they wish to permit the system to access and process their data. By using this opt-in model, the system may help ensure that it only collects and uses data from users who have explicitly agreed to such collection and use.

For instance, if the system needs to gather biometric data like facial recognition details for a more personalized user experience or eye-tracking data for assessing user engagement, it may first inform the user about these requirements. The user may be provided with an opt-in prompt detailing the types of biometric data to be collected, the purpose of this collection, and the benefits that such data can bring to the user's experience. In the case of eye-tracking data, the system might explain that this data helps provide insights into which aspects of the interface are engaging to the user or can be used to optimize the layout of content for better usability. Similarly, for facial recognition data, the system could clarify that this information would enable more secure authentication or could enhance personalization within the system, making the user's experience more seamless and convenient.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

The process software for collaboration mode transition based on cognitive overload is integrated into a client, server and network environment, by providing for the process software to coexist with applications, operating systems and network operating systems software and then installing the process software on the clients and servers in the environment where the process software will function.

The integration process identifies any software on the clients and servers, including the network operating system where the process software will be deployed, that are required by the process software or that work in conjunction with the process software. This includes software in the network operating system that enhances a basic operating system by adding networking features. The software applications and version numbers will be identified and compared to the list of software applications and version numbers that have been tested to work with the process software. Those software applications that are missing or that do not match the correct version will be updated with those having the correct version numbers. Program instructions that pass parameters from the process software to the software applications will be checked to ensure the parameter lists match the parameter lists required by the process software. Conversely, parameters passed by the software applications to the process software will be checked to ensure the parameters match the parameters required by the process software. The client and server operating systems, including the network operating systems, will be identified and compared to the list of operating systems, version numbers and network software that have been tested to work with the process software. Those operating systems, version numbers and network software that do not match the list of tested operating systems and version numbers will be updated on the clients and servers in order to reach the required level.

After ensuring that the software, where the process software is to be deployed, is at the correct version level that has been tested to work with the process software, the integration is completed by installing the process software on the clients and servers.

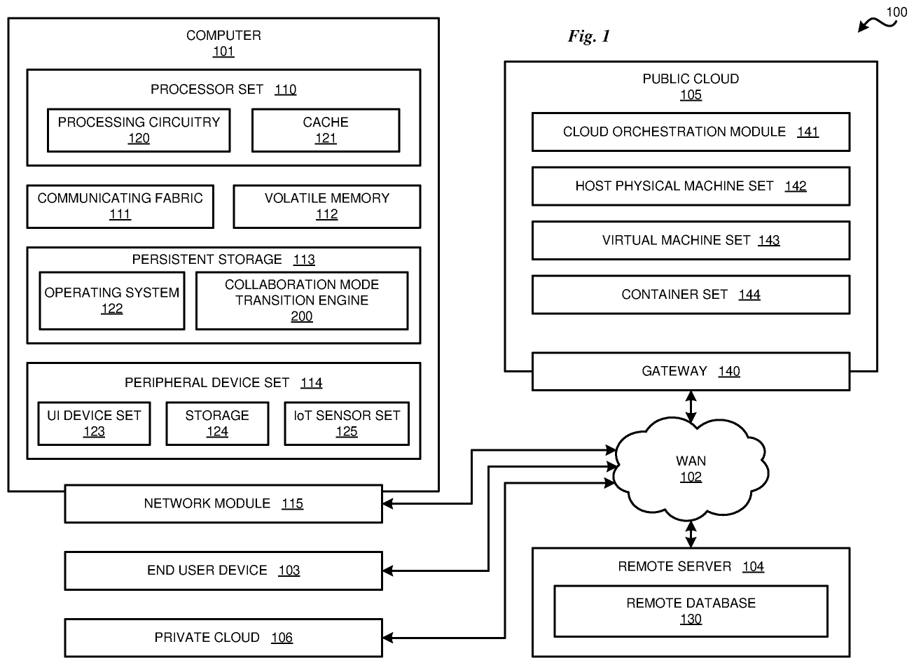

With reference to FIG. 1, this figure depicts a block diagram of a computing environment 100. Computing environment 100 contains an example of an environment for the execution of at least some of the computer code involved in performing the inventive methods, such as collaboration mode transition engine 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

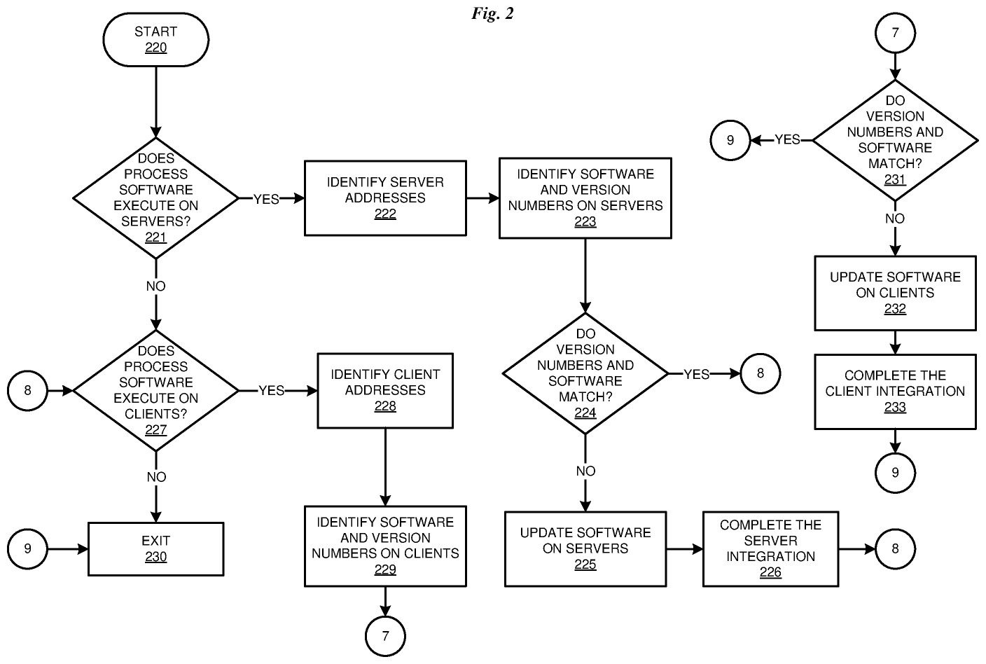

With reference to FIG. 2, this figure depicts a block diagram of an example software integration process, which various illustrative embodiments may implement. Step 220 begins the integration of the process software. An initial step is to determine if there are any process software programs that will execute on a server or servers (221). If this is not the case, then integration proceeds to 227. If this is the case, then the server addresses are identified (222). The servers are checked to see if they contain software that includes the operating system (OS), applications, and network operating systems (NOS), together with their version numbers that have been tested with the process software (223). The servers are also checked to determine if there is any missing software that is required by the process software (223).

A determination is made if the version numbers match the version numbers of OS, applications, and NOS that have been tested with the process software (224). If all of the versions match and there is no missing required software, the integration continues (227).

If one or more of the version numbers do not match, then the unmatched versions are updated on the server or servers with the correct versions (225). Additionally, if there is missing required software, then it is updated on the server or servers (225). The server integration is completed by installing the process software (226).

Step 227 (which follows 221, 224 or 226) determines if there are any programs of the process software that will execute on the clients. If no process software programs execute on the clients, the integration proceeds to 230 and exits. If this not the case, then the client addresses are identified (228).

The clients are checked to see if they contain software that includes the operating system (OS), applications, and network operating systems (NOS), together with their version numbers that have been tested with the process software (229). The clients are also checked to determine if there is any missing software that is required by the process software (229).

A determination is made if the version numbers match the version numbers of OS, applications, and NOS that have been tested with the process software (231). If all of the versions match and there is no missing required software, then the integration proceeds to 230 and exits.

If one or more of the version numbers do not match, then the unmatched versions are updated on the clients with the correct versions 232. In addition, if there is missing required software, then it is updated on the clients 232. The client integration is completed by installing the process software on the clients 233. The integration proceeds to 230 and exits.

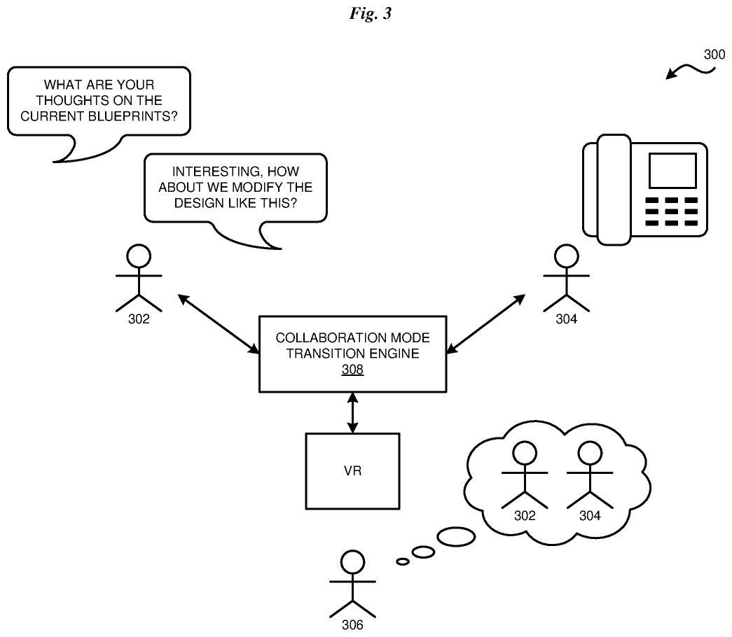

With reference to FIG. 3, this figure depicts a graphical representation of an example collaborative environment 300. It is to be understood that a collaborative environment may comprise other modes of communications such as video conferencing, shared virtual workspaces, or collaborative editing platforms, as would be appreciated by those having ordinary skill in the art upon reviewing the present disclosure.

In the depicted example, collaborative environment 300 may comprise user 302, user 304, and user 306. Each user may represent a different mode of communication within the collaborative environment. This configuration demonstrates the system's ability to cater to diverse communication preferences and technology access levels, which may enable a more inclusive and effective collaboration platform.

User 302 may utilize a textual collaboration application, such as a messaging application. This scenario may represent a form of collaboration whereby the user sends and receives information in a text format. For instance, the user may be working on a smartphone or may prefer textual communication for its simplicity. In a specific interaction, user 302 might send a message such as “What are your thoughts on the current blueprints?” to which another user may reply “Interesting, how about we modify the design like this?” illustrating the dynamics of the collaboration.

User 304 may utilize an auditory collaboration application, which may be facilitated through devices like a telephone, a computer with Voice over Internet Protocol (VOIP) capabilities, or a smartphone. User 304 could be in a situation where audio communication is more practical and effective.

User 306 may utilize a virtual reality collaboration application, such as by engaging with the collaborative environment through a virtual reality headset or similar immersive technology. This immersive approach may provide an engaging experience that may closel mimics physical presence and interaction. User 306 might be engaged in a complex collaborative task that benefits from the visual, spatial, and interactive advantages that virtual reality offers.

As further shown, users 302, 304, and 306 may collaborate together by interacting with collaboration mode transition engine 308. This engine may manage the collaborative environment, processing the different modes of communication, managing transitions between them, and ensuring that information is seamlessly and effectively communicated between users, regardless of their chosen mode.

To illustrate, user 306, who operates in the virtual reality mode, may view users 302 and 304 as virtual reality avatars in their immersive environment, despite them interacting with the engine using different collaboration modes. The transition engine may translate the text and audio inputs from users 302 and 304 into visual and spatial data that can be represented in virtual reality. This capacity for translation and adaptation across modes may aid in fostering inclusive, efficient, and dynamic collaborative environments.

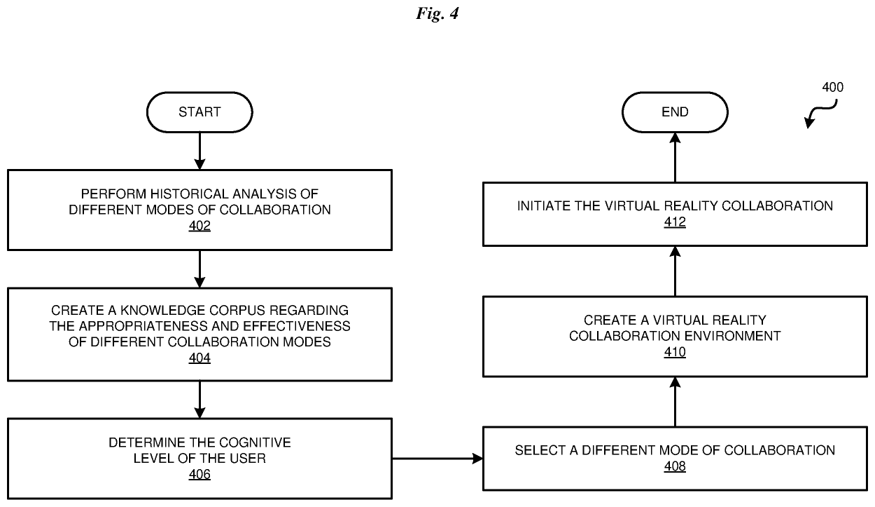

With reference to FIG. 4, this figure depicts a block diagram of an example process for collaboration mode transition in accordance with an illustrative embodiment 400. The example block diagram of FIG. 4 may be implemented using collaboration mode transition engine 200 of FIG. 1.

In the illustrative embodiment, at block 402, the process may perform historical analysis of different modes of collaboration. This analysis might involve gathering data from multiple sources such as direct user feedback, usage statistics, performance metrics, and captured data. The data could include elements such as biometrics data (e.g., heart rate or breathing rate), the users' facial expressions (e.g., from face capture technology), distractions identified in the users' environment, the duration of collaborative sessions, the number of breaks taken, and users' subjective perceptions of fatigue or satisfaction. The system may then apply machine learning algorithms to this data, identifying patterns and trends that indicate the endurance levels and cognitive capacities of the users in relation to different collaboration modes.

For example, in some embodiments, the process may involve training a deep learning algorithm. The deep learning algorithm may be trained using a variety of data inputs, including facial images of users, biometric data, user feedback and more. The deep learning algorithm may learn to discern patterns related to fatigue levels based on these different data sets, creating a robust and dynamic understanding of user cognitive state. For instance, visible signs of fatigue in facial images could be used as a potential indicator of a need for a transition in the collaboration mode. Similarly, the deep learning model could use biometric data to understand physical responses to different collaboration modes. This approach to deep learning model training may allow for a comprehensive and accurate picture of users' cognitive state and endurance level in the context of different collaboration modes.

Training the model may involve splitting data into a training set and a test set. The training set may be used to teach the model how to interpret the data, with the deep learning algorithm adjusting its internal parameters to minimize the difference between its predictions and the actual outcomes. The test set, on the other hand, may be used to verify the model's predictive performance on unseen data. This learning process could be guided by a loss function, which quantifies the difference between the predicted and actual outcomes. The objective of the training process may be to adjust the model's parameters in a way that minimizes this loss function. This can be achieved through optimization algorithms such as stochastic gradient descent (SGD), which iteratively adjust the model's parameters in the direction that reduces the loss. Any other training process may be used, however, depending on the specific model and application, as would be appreciated by those having ordinary skill in the art upon reviewing the present disclosure.

At block 404, the process may create a knowledge corpus regarding the appropriateness and effectiveness of different collaboration modes. This corpus may be a structured database of insights, derived from the analysis of a variety of data sources. This could include the data noted previously, such as biometrics data, facial expressions, identified distractions, data from user feedback, usage statistics, behavioral analytics, and external information. As noted, machine learning algorithms might be applied to this data to extract patterns and trends, generating insights about the most effective collaboration modes for different contexts and tasks. For instance, the knowledge corpus might indicate that visual collaboration modes such as video conferencing or shared whiteboards may be particularly effective for brainstorming sessions, while textual collaboration modes such as instant messaging may be more appropriate for more procedural or administrative tasks.

At block 406, the process may determine a cognitive level of the user. This process may involve real-time monitoring of user behavior and interactions within the collaboration environment. This process may involve the use of a variety of data points for this evaluation, such as the speed and accuracy of the user's inputs, the frequency and pattern of their interactions, biometric data such as heart rate or breathing rate, facial expressions, eye fatigue or movements, or identified distractions. Analytics algorithms could be used to interpret this data, identifying signs of cognitive fatigue or disengagement that might suggest a need for a change in the mode of collaboration.

At block 408, if the process identifies signs of cognitive fatigue or decreased effectiveness, it may select a different mode of collaboration. The choice of the new mode may be guided by the knowledge corpus, which provides insights into the most effective modes for various contexts. For example, if the user appears to be struggling with a complex problem-solving task in a text-based collaboration mode, the system might suggest switching to a visual collaboration mode that might be better suited to the task. This transition may aim to re-engage the user and maintain the effectiveness of the collaborative process.

In the depicted example, for instance, as shown in block 410, if the process determines to transition to a virtual reality mode, it may create a virtual reality collaboration environment. This process may involve analyzing collaboration contents, participant profiles, and typing speeds to inform the process of creating a virtual reality collaboration environment that is well-suited to the needs and preferences of the users. For instance, if the collaboration content involves complex visual data, the virtual reality environment might be designed to provide data visualization capabilities. If the participant profiles indicate a preference for non-verbal communication, the virtual reality environment could include features such as gesture recognition or virtual avatars.

At block 412, the system may initiate the virtual reality collaboration. This step may involve executing the virtual reality environment according to the preferences and requirements identified through the analysis, and then transitioning the participants into this environment. This process could involve presenting the users with virtual reality headsets or other necessary equipment, guiding them through the process of entering the virtual reality environment, and providing any necessary training or orientation. Once the participants are in the virtual reality environment, they can continue their collaborative process with renewed engagement and effectiveness, benefiting from the immersive, interactive, and versatile capabilities that virtual reality collaboration offers.

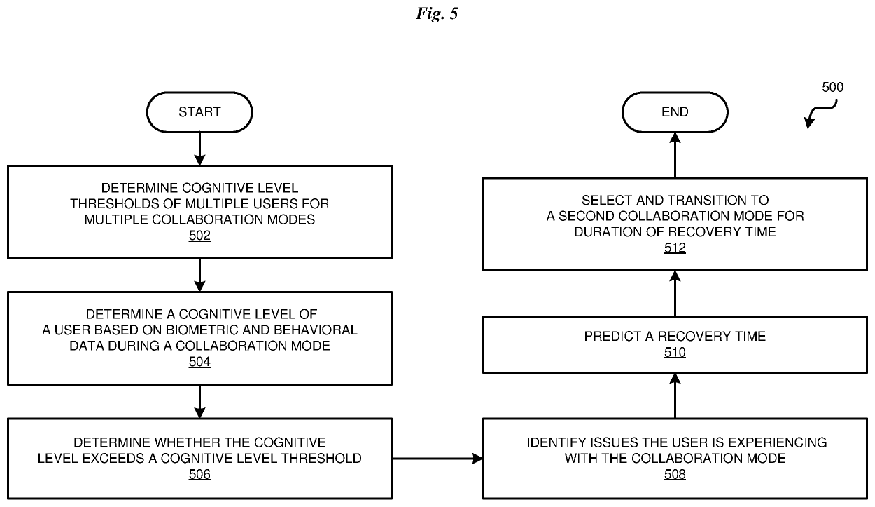

With reference to FIG. 5, this figure depicts a block diagram of an example process for collaboration mode transition based on cognitive overload in accordance with an illustrative embodiment 500. The example block diagram of FIG. 5 may be implemented using collaboration mode transition engine 200 of FIG. 1.

In the illustrative embodiment, at block 502, the process may determine cognitive level thresholds of multiple users for multiple collaboration modes. This process may involve gathering user data over a period of time, from a variety of collaboration modes. Examples of collaboration modes might include face-to-face meetings, phone calls, email exchanges, instant messaging sessions, and so on. The process may record various parameters related to these collaboration sessions, such as those mentioned previously, including biometrics data, facial expression data, identified distractions, data from user feedback, usage statistics, behavioral analytics, and external information. Machine learning algorithms could then be used to analyze this data, identifying patterns related to users' endurance levels in different collaboration modes.

At block 504, the process may determine a cognitive level of a user based on biometric and behavioral data during a collaboration mode. This process may involve integrating with devices or software that can capture relevant data, such as smartphones, smartwatches, fitness trackers, and collaboration software. The biometric data might include heart rate, breathing rate, skin temperature, and eye movements, while behavioral data might include typing speed, mouse movements, response times, and usage patterns of the collaboration tools. The process may use algorithms to analyze this data, identifying signs of fatigue, stress, or disengagement that might suggest a need for a break or a switch to a different collaboration mode.

For example, the process may capture biometric data such as heart rate and breathing rate by using wearable technology like a smartwatch or fitness tracker, which may be equipped with sensors such as photoplethysmography sensors for heart rate monitoring and accelerometers for movement tracking. Additionally, it may determine facial expression data through technologies such as computer vision, specifically facial recognition software, that can analyze video feeds from webcams or dedicated cameras to understand changes in user facial emotions or states. Furthermore, it may determine distractions in the user's environment by using sensors like ambient noise detectors or light sensors that can pick up fluctuations in the environmental conditions around the user. Machine learning algorithms could then analyze this data to recognize potential distractions or disruptions in the user's workspace that may negatively impact the collaborative process.

At block 506, the process may determine whether the endurance score exceeds an endurance score threshold. This process may involve continuously monitoring the biometric and behavioral data captured during the collaboration, and comparing these data against the user's historical data and the general patterns identified in the system's historical learning. If the data suggests that the user is nearing their endurance limit (for instance, if their heart rate and breathing rate are decreasing, their typing speed is decreasing, or they are making more errors than usual) the process may switch to a different collaboration mode, send a notification to the user, or suggest a break.

At block 508, if the process determines that the endurance score exceeds the endurance score threshold, the process may identify issues the user is experiencing with the collaboration mode. This process might involve analyzing the user's performance and feedback in the current collaboration mode, identifying any difficulties or challenges they may be experiencing. For instance, the user might struggle to stay engaged in long video conferences, find it difficult to keep track of complex email threads, or feel stressed by the fast pace of instant messaging discussions. By identifying these problems, the system may provide personalized suggestions for improving the collaboration experience, such as suggesting different collaboration modes, providing tips for more effective use of the tools, or recommending adjustments to the collaboration schedule or format.

For example, the process may identify problems such as low response time through monitoring user interaction with the collaboration tools, with an increasing lag in response times potentially indicating fatigue or loss of focus. This could be achieved by time-stamping user interactions and tracking changes in these timestamps over time. Low response accuracy could be determined by natural language processing algorithms that analyze the quality and relevance of user inputs. High amounts of blinking could be identified using eye-tracking technologies that monitor user eye movements and blinking rates, often embedded in high-end webcams or standalone eye-tracking devices. Changes in pupil size, another potential sign of cognitive stress or strain, can also be monitored using similar eye-tracking technologies.

At block 510, the process may predict a recovery time. This process might involve predicting how the user's biometric and behavioral indicators will change after a switch from one collaboration mode to another. For example, the system might predict that the user's heart rate decreases, their mood improves, or their productivity increases after switching from a video conference to an email exchange. This analysis could provide insights into how long it will take for the user to recover from the fatigue or stress of one collaboration mode, and how quickly they can adapt to a new mode.

At block 512, the process may select and transition to a second collaboration mode for the duration of the recovery time. This process may involve using the insights gained from the historical learning, the problems identified, and the ongoing analysis of the user's data to suggest the most suitable modes for the user and the most effective ways to switch between them. For instance, the system might suggest that a user who gets fatigued during long video conferences could switch to asynchronous email exchanges for a while, then take a short break, then join a collaborative document editing session. These suggestions may aim to maintain the user's engagement and productivity while preventing burnout or excessive fatigue.

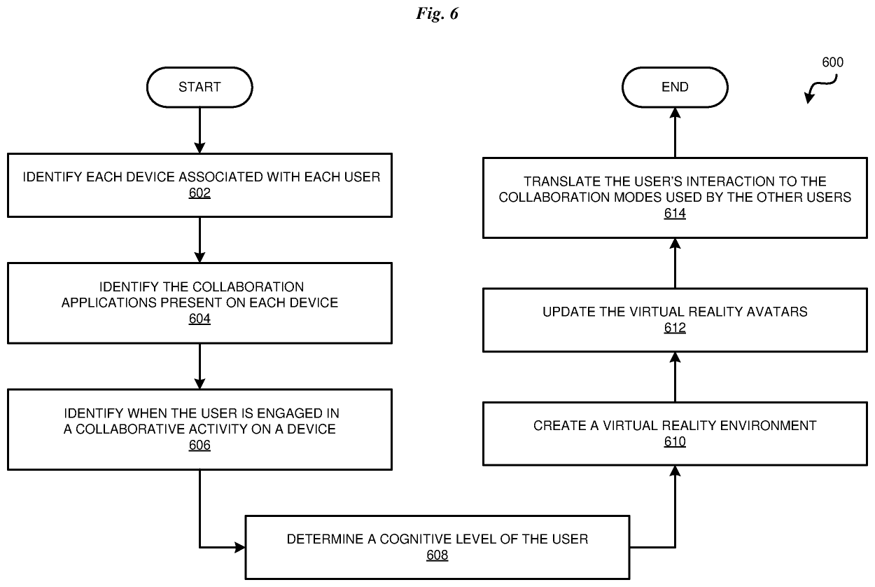

With reference to FIG. 6, this figure depicts a block diagram of an example process for transitioning to a virtual reality collaboration mode in accordance with an illustrative embodiment 600. The example block diagram of FIG. 6 may be implemented using collaboration mode transition engine 200 of FIG. 1.

In the illustrative embodiment, at block 602, the process may identify each device associated with each user, such as a smartphone, a personal computer, or smart glasses, among others. This identification process may leverage various techniques, including geolocation tracking that identifies devices based on their global positioning coordinates, device-specific identifications like International Mobile Equipment Identity (IMEI) for mobile devices, MAC addresses for networking devices, or through user selection. The system may detect these devices either by scanning the user's local network for recognizable device signatures, requesting device permissions from the operating system, or asking the user to manually input which devices they would like to use for collaborative activities.

At block 604, the process may identify the collaboration applications present on each device. For instance, a mobile phone could have textual communication applications installed, while a laptop might include virtual reality collaboration platforms. This identification process may be achieved via device-level permission requests that grant the system the ability to scan for installed applications or by having the user manually indicate which applications they typically utilize for collaboration. A system-to-application handshake could involve delegated authorization protocols (e.g., OAuth), token-based authentication, or application programming interface (API) calls.

At block 606, the process may identify when the user is engaged in a collaborative activity on a device. This collaboration could take various forms. For instance, the user could be immersed in a virtual reality meeting, making a conference call through their laptop, or texting a colleague on their mobile phone. The system may monitor activity levels on the recognized collaboration applications, utilizing user input or leveraging techniques like machine learning algorithms for activity detection. A combination of application usage data, system-level event logs, and pattern recognition can help identify these activity patterns.

At block 608, the system may determine a cognitive level of the user. This process may involve the analysis of various facets of user engagement, such as interaction patterns (like the frequency and duration of glances), gaze focus (which could involve tracking the direction and stability of the gaze), and signs of fatigue (identified by frequent blinking or closed eyelids), as mentioned previously. The process may employ, for instance, eye-tracking technologies and algorithms capable of analyzing webcam data or specialized eye-tracking devices. The system may then dynamically orchestrate a switch between virtual reality and textual communications based on predefined biometric thresholds, ensuring that the user's cognitive load is managed effectively, thereby enhancing the overall collaborative experience.

At block 610, the process may create a virtual reality environment. The process may leverage eye analytics and inputs from text messages or calls to dynamically create avatars in the virtual reality environment. For instance, an incoming text message from a colleague on the user's mobile phone might trigger the system to generate a virtual avatar representing the sender. This avatar creation could be based on predefined templates, custom user profiles, or machine learning-driven generative models, and may be supplemented with a visual indication of the incoming message or call, like a speech bubble or a virtual phone.

At block 612, the process may update the virtual reality avatars. This process may involve modifying the virtual reality avatars with body language and gesture dynamics that align with the sentiment and context of the conversation. Such contextual cues may be derived using natural language processing and/or sentiment analysis techniques on the textual or verbal input. For instance, if the conversation is friendly, the avatar might exhibit open body language and positive gestures, while a serious discussion might be reflected in more formal body language.

For example, as the user begins their interaction in the virtual reality environment, the virtual reality avatars may come alive in the virtual world and commence their interaction with the user. The process may control the avatars' movements and responses using a combination of predefined gesture sets, rule-based machine learning systems, or machine learning algorithms trained on real-world non-verbal communication data.

In some embodiments, the process may take into account a user's personalized information in updating the virtual reality environment (or any other translation between different modes of collaboration), such as familiar applications, cultural background, and impairments. For instance, when considering familiar applications, the process aims to create a continuity of user experience as the transition to the virtual reality environment occurs. To do this, the process might analyze the applications regularly used by the user in their physical world, identifying features, interfaces, or elements that can be replicated in the virtual reality environment. For example, if a user frequently uses a specific communication application that utilizes distinctive visual elements like emojis, these elements can be imported into the virtual environment. This import process might involve application programming interfaces to access these elements or machine learning algorithms to recognize and replicate these elements in the virtual environment. Moreover, the system can create a personal library of commonly used emojis based on the frequency of usage to further tailor the virtual environment to the user's preferences.

The process may also take into account a user's cultural background. To ensure that the virtual reality environment aligns with the user's cultural and linguistic context, the system could consider multiple factors. For instance, it might analyze the language used during collaboration or sourced from the operating system settings. It could also recognize cultural-specific communication norms and customs. For instance, certain cultures may use specific idiomatic expressions, non-verbal cues, or gestures that are unique to their cultural background. By integrating these cultural elements, the process can create an environment that accurately reflects the user's real-world communication norms and practices, thus promoting effective and respectful collaboration among diverse users.

Additionally, the system could consider potential user impairments. Depending on the specific impairment, the system can integrate various assistive technologies into the virtual reality environment to facilitate the user's engagement. For visually impaired users, this might involve integrating screen reader software or creating high-contrast or larger visual elements. For users with hearing impairment, the system could incorporate automated sign language translation solutions. These adaptations may be derived from user-specific settings, allowing for customization based on the individual's needs and preferences. By accommodating these impairments, the system may ensure a more inclusive virtual reality environment where all users can effectively engage and participate.

At block 614, the process may translate the user's interaction to the collaboration modes used by the other users. For instance, as the user starts interacting with the virtual environment, this information may be translated and transmitted to the other receiving users via text or by call. For example, a conversation happening in the virtual world might be transcribed using automatic speech recognition systems and sent as a text message to a user who is using textual communication, or it could be converted into voice data using text-to-speech systems and delivered as a phone call to another user. This process may ensure that every user stays connected and informed, irrespective of their preferred mode of collaboration.

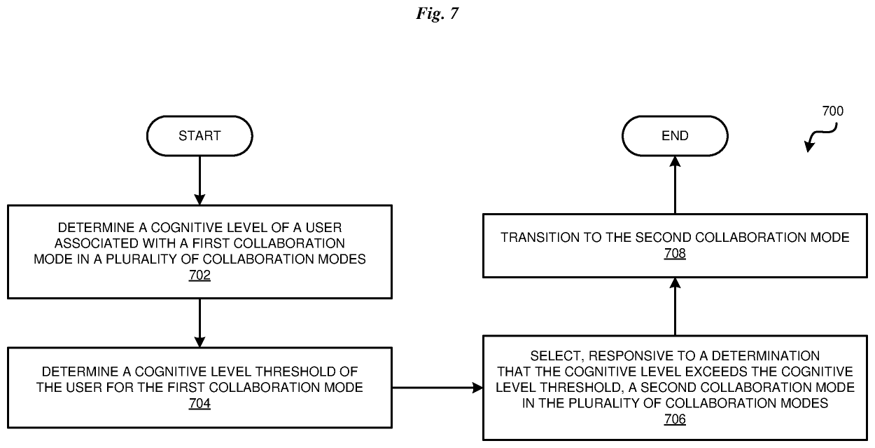

With reference to FIG. 7, this figure depicts a block diagram of an example process for collaboration mode transition based on cognitive overload in accordance with an illustrative embodiment 700. The example block diagram of FIG. 7 may be implemented using collaboration mode transition engine 200 of FIG. 1.

In the illustrative embodiment, at block 702, the process may determine a cognitive level of a user associated with a first collaboration mode in a plurality of collaboration modes. This determination may be based on a combination of biometric and behavioral data. Biometric data could include heart rate data, breathing rate data, facial expressions data, or any other suitable data, as previously explained. Behavioral data may encompass elements such as engagement duration in the collaboration mode, task performance metrics, points of lost focus or signs of fatigue, among others, as previously noted. The system may employ machine learning models to determine the cognitive level of the user.

At block 704, the process may determine a cognitive level threshold of the user for the first collaboration mode. This determination may be based on collaboration mode usage data related to the first collaboration mode. This data may provide a detailed view of the user's interaction patterns, task completion rates, error rates, break intervals, and other relevant metrics in the particular collaboration mode. A deep learning model, trained on diverse user data, may process this information and output a cognitive level threshold. This threshold may signify the maximum or near-maximum cognitive load the user can handle in the first collaboration mode before their begin to experience discomfort or cognitive overload.

At block 706, the process may select, responsive to a determination that the cognitive level exceeds the cognitive level threshold, a second collaboration mode in the plurality of collaboration modes. This step may indicate whether the user is close to or has already reached a state of cognitive overload in the current collaboration mode. If the user's cognitive level surpasses the threshold, the system may select an alternative collaboration mode from the array of available modes. The selection of this second mode may be based on comprehensive data analysis. The system considers factors such as the user's past performance and comfort in different modes, the complexity and urgency of the task at hand, and the cognitive demand of alternative modes. The system may employ a machine learning model to select the second machine learning model

At block 708, the process may transition to the second collaboration mode. This transition may ensure minimal disruption to the user's work process. The system automatically may adjust user interfaces, interaction methods, and collaboration tools to align with the second mode's requirements. For instance, if the user is transitioning from a virtual reality mode to a text-based mode, the system may provide a textual summary of the ongoing discussions, adapt the display settings, and provide appropriate text entry tools. This entire process may provide a proactive approach to managing cognitive load during collaborative efforts, enabling users to maintain optimal productivity while preventing cognitive overload.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
determining, by a collaboration mode transition engine, based on biometrics data and behavioral data, a cognitive level of a user associated with a first collaboration mode in a plurality of collaboration modes;
determining, by the collaboration mode transition engine, based on collaboration mode usage data associated with the first collaboration mode, a cognitive level threshold of the user for the first collaboration mode;
selecting, by the collaboration mode transition engine, responsive to a determination that the cognitive level exceeds the cognitive level threshold, a second collaboration mode in the plurality of collaboration modes; and
transitioning, by the collaboration mode transition engine, to the second collaboration mode.

2. The method of claim 1, wherein the collaboration mode transition engine comprises a machine learning model trained to determine the cognitive level threshold based on a plurality of cognitive level thresholds from a plurality of users and trained to determine the cognitive level based on a plurality of cognitive levels from the plurality of users, further comprising:
applying the machine learning model to the collaboration mode usage data to determine the cognitive level threshold of the user; and
applying the machine learning model to the biometrics data and behavioral data to determine the cognitive level of the user.

3. The method of claim 1, further comprising:
translating a user interaction of a second user to the second collaboration mode.

4. The method of claim 1, wherein the second collaboration mode is a virtual reality collaboration mode, and wherein transitioning to the second collaboration mode further comprises:
creating a virtual reality collaboration environment; and
initiating a virtual reality collaboration in the virtual reality collaboration environment.

5. The method of claim 4, further comprising:
generating a virtual reality avatar associated with a second user interacting with a third collaboration mode;
translating a user interaction of the second user in the third collaboration mode to the virtual reality collaboration environment; and
updating, based on the translating, the virtual reality avatar of the second user.

6. The method of claim 1, further comprising:
predicting a recovery time for the user; and
remaining in the second collaboration mode for at least the recovery time.

7. The method of claim 1, further comprising:
identifying a plurality of devices associated with the user;
identifying a plurality of collaboration applications from the plurality of devices; and
identifying the plurality of collaboration modes from the plurality of collaboration applications.

8. The method of claim 1, wherein the behavioral data includes at least one of response time data, response accuracy data, and distraction data.

9. The method of claim 1, wherein the biometrics data includes at least one of heart rate data, breathing rate data, and facial expression data.

10. A computer program product comprising one or more computer readable storage media, and program instructions collectively stored on the one or more computer readable storage media, the program instructions executable by a processor to cause the processor to perform operations comprising:
determining, by a collaboration mode transition engine, based on biometrics data and behavioral data, a cognitive level of a user associated with a first collaboration mode in a plurality of collaboration modes;
determining, by the collaboration mode transition engine, based on collaboration mode usage data associated with the first collaboration mode, a cognitive level threshold of the user for the first collaboration mode;
selecting, by the collaboration mode transition engine, responsive to a determination that the cognitive level exceeds the cognitive level threshold, a second collaboration mode in the plurality of collaboration modes; and
transitioning, by the collaboration mode transition engine, to the second collaboration mode.

11. The computer program product of claim 10, wherein the collaboration mode transition engine comprises a machine learning model trained to determine the cognitive level threshold based on a plurality of cognitive level thresholds from a plurality of users and trained to determine the cognitive level based on a plurality of cognitive levels from the plurality of users, further comprising:
applying the machine learning model to the collaboration mode usage data to determine the cognitive level threshold of the user; and
applying the machine learning model to the biometrics data and behavioral data to determine the cognitive level of the user.

12. The computer program product of claim 10, further comprising:
translating a user interaction of a second user to the second collaboration mode.

13. The computer program product of claim 10, wherein the second collaboration mode is a virtual reality collaboration mode, and wherein transitioning to the second collaboration mode further comprises:
creating a virtual reality collaboration environment;
initiating a virtual reality collaboration in the virtual reality collaboration environment;
generating a virtual reality avatar associated with a second user interacting with a third collaboration mode;
translating a user interaction of the second user in the third collaboration mode to the virtual reality collaboration environment; and
updating, based on the translating, the virtual reality avatar of the second user.

14. The computer program product of claim 10, further comprising:
predicting a recovery time for the user; and
remaining in the second collaboration mode for at least the recovery time.

15. The computer program product of claim 10, further comprising:
identifying a plurality of devices associated with the user;
identifying a plurality of collaboration applications from the plurality of devices; and
identifying the plurality of collaboration modes from the plurality of collaboration applications.

16. A computer system comprising a processor and one or more computer readable storage media, and program instructions collectively stored on the one or more computer readable storage media, the program instructions executable by the processor to cause the processor to perform operations comprising:
determining, by a collaboration mode transition engine, based on biometrics data and behavioral data, a cognitive level of a user associated with a first collaboration mode in a plurality of collaboration modes;
determining, by the collaboration mode transition engine, based on collaboration mode usage data associated with the first collaboration mode, a cognitive level threshold of the user for the first collaboration mode;
selecting, by the collaboration mode transition engine, responsive to a determination that the cognitive level exceeds the cognitive level threshold, a second collaboration mode in the plurality of collaboration modes; and
transitioning, by the collaboration mode transition engine, to the second collaboration mode.

17. The computer system of claim 16, wherein the collaboration mode transition engine comprises a machine learning model trained to determine the cognitive level threshold based on a plurality of cognitive level thresholds from a plurality of users and trained to determine the cognitive level based on a plurality of cognitive levels from the plurality of users, further comprising:
applying the machine learning model to the collaboration mode usage data to determine the cognitive level threshold of the user; and
applying the machine learning model to the biometrics data and behavioral data to determine the cognitive level of the user.

18. The computer system of claim 16, further comprising:
translating a user interaction of a second user to the second collaboration mode.

19. The computer system of claim 16, wherein the second collaboration mode is a virtual reality collaboration mode, and wherein transitioning to the second collaboration mode further comprises:
creating a virtual reality collaboration environment;
initiating a virtual reality collaboration in the virtual reality collaboration environment;
generating a virtual reality avatar associated with a second user interacting with a third collaboration mode;
translating a user interaction of the second user in the third collaboration mode to the virtual reality collaboration environment; and
updating, based on the translating, the virtual reality avatar of the second user.

20. The computer system of claim 16, further comprising:
predicting a recovery time for the user, and
remaining in the second collaboration mode for at least the recovery time.
